(19) United States
(12) Patent Application Publication
(10) Pub. No.: US 2009/0288998 A1
(43) Pub. Date: Nov. 26, 2009

(54) Water separating fuel filter with limited removal capability for a water detecting sensor

(75) Inventors: Matthew W. Jaeger, Stillwater, OK (US); Kyle A. Stein, Stillwater, OK (US)

Correspondence Address: WILLIAM D. LANYI, MERCURY MARINE, W6250 PIONEER ROAD P.O. BOX 1939, FOND DU LAC, WI, 54936-1939, US

(73) Assignee: Brunswick Corporation

(21) Appl. No.: 11/432,842

(22) Filed: May 12, 2006

(51) Int. Cl. B01D 35/34; F02M 37/22

(52) U.S. Cl. 210/86; 210/452; 210/232; 210/243

(57) ABSTRACT

A water separating fuel filter is provided with a sensor at its bottom portion which is not removable in a direction away from the housing structure of the filter mechanism. In other words, if the sensor is removable at all, it must be removed in a direction which requires the sensor to move through the cavity of the housing structure of the filter while preventing an internal end of the sensor from passing in a direction away from the cavity and through a portion of the wall of the housing structure through which the sensor extends during operation. This eliminates the likelihood of a sensor being inadvertently removed from the housing structure and not properly replaced prior to subsequent operation of a fuel system of an internal combustion engine. This, in turn, prevents the condition wherein an opening at the bottom portion of the fuel filter housing structure can allow liquid fuel to flow from the fuel system into the bilge of a watercraft.

### BACKGROUND OF THE INVENTION

1. Field of the Invention

The present invention is generally related to a water detecting fuel filter and, more particularly, to a filter structure which limits the ways in which a water detecting sensor can be removed from a housing structure of the water separating fuel filter device.

2. Description of the Related Art

Many different types of water separating fuel filters and water detectors are known to those skilled in the art. The purpose of the filter is to remove water from liquid fuel. The purpose of the water detecting sensor is to determine when water, is within the structure of the fuel filter, is of a sufficient quantity to necessitate its removal.

U.S. Pat. No. 4,515,690, which issued to Yasuhara on May 7, 1985, describes a fuel supply system for diesel engines. An apparatus is provided informing when a filter located in a fuel passage between a fuel tank and a fuel injection pump has clogged a predetermined amount. The apparatus is responsive to fuel pressure downstream of the filter to provide an indication when the sensed pressure is below a predetermined value. A device for draining water separated from the fuel is also described.

U.S. Pat. No. 4,562,431, which issued to Jahnke et al. on Dec. 31, 1985, describes a fuel filter unit with water content indicator. Corrosion of a water sensor resulting from the passage of considerable electric current through it while it is in contact with water is prevented in a motor fuel filter equipped for water separation by interrupting or greatly reducing the current passing through the sensor after the sensor has given a signal indicating the presence of water in sufficient quantity to require draining soon. The warning provided to the vehicle driver is maintained thereafter either by a signal storage unit or by causing current diverted from the sensor to flow through the substitution resistor or a shunt transistor.

U.S. Pat. No. 4,594,892, which issued to Asmundsson on Jun. 17, 1986, describes a capacitance probe for liquid level measuring systems. A liquid level measurement capacitance probe is disclosed comprising an elongated outer capacitor tube, an elongated inner tube coaxially mounted within the outer capacitor tube to form a capacitor annulus therebetween with the inner tube having a plurality of longitudinally extending capacitor elements cooperating with the outer capacitor tube to form a plurality of individual capacitor units, a connector unit for electrically connecting the capacitor units to an electronic circuit processor for measuring capacitance values of the capacitor units in calculating a fluid level, a filter for separating water from fuel flowing from the storage tank to be measured to the capacitor annulus, the filter having an annular housing mounted about the outer capacitor tube with an inlet port adapted for fluid communication with the storage tank and an outer port connected to the capacitor annulus between the inner and outer capacitor tube for delivery of filtered fuel to the annulus.

U.S. Pat. No. 5,993,675, which issued to Hagerthy on Nov. 30, 1999, describes a fuel water separator for marine and diesel engines. The device provides a method for separating fuel from water in a marine propulsion system and a reusable device for separating water from fuel in marine and diesel engines thereby preventing or limiting water from entering the combustion process of the engine.

U.S. Pat. No. 6,676,841, which issued to Akins et al. on Jan. 13, 2004, describes a water-in-fuel abuse detection system. It provides a way to determine if a vehicle operator has ignored a conventional in-fuel indicator light and continued to operate the vehicle beyond a certain threshold. The system includes a sensor positioned in a fuel filter capable of separating an amount of water from a source of fuel. The sensor is operatively connected to a software routine, as well as to a conventional indicator light that illuminates to alert a vehicle operator that water must be purged from the fuel filtration system.

U.S. Pat. No. 6,923,165, which issued to Draves et al. on Aug. 2, 2005, discloses a fuel system for a marine propulsion device. The system is provided with a fuel distribution member that has a plurality of passages formed within its unitary structure to allow a water separating fuel filter and a pressure regulator to be attached directly to the fuel distribution member without the need of conduits and hoses connected therebetween. The fuel is received from a mechanical fuel pump and directed through the water separating fuel filter to a fuel manifold that includes first and second fuel rails. The fuel is cooled and pumped through a high pressure fuel filter as it flows to the fuel manifold. The pressure regulator has a pressure relief conduit that returns fuel to the fuel filter for recirculation.

The patents described above are hereby expressly incorporated by reference in the description of the present invention.

### SUMMARY OF THE INVENTION

A filter device, made in accordance with the preferred embodiment of the present invention, comprises a housing structure which defines a cavity therein, a filter medium disposed within the housing structure, and a sensor extending through a portion of a wall of the housing structure. The sensor has an internal end disposed within the cavity and an external end which extends away from the housing structure. The sensor is configured to prevent the sensor from being removed from the housing structure in a direction which causes the internal end to pass through the portion of the wall in a direction away from the cavity.

In a particularly preferred embodiment of the present invention, the filter device is a water separating fuel filter. The sensor can be removable from the portion of the wall in a direction into the cavity. The portion of the wall can be proximate a bottom of the housing structure when the filter is operative. In other words, when the filter device is attached to a fuel system of an internal combustion engine, the portion of the wall is disposed at a bottom portion of the housing structure. The sensor can be a water detecting sensor and can comprise an electrically conductive core. The electrically conductive core can be made of stainless steel. The sensor can further comprise an electrically insulative member disposed between the electrically conductive core and the portion of the wall. The electrically insulative member can be made of plastic, an elastomeric material, or a ceramic material. It should be understood that the specific material used to provide the electrically insulative member is not limiting to the present invention.

The sensor can be prevented from being removed from the housing structure, in a direction which causes the internal end to pass through the portion of the wall in a direction away from the cavity, by a flange element which is attached to the sensor and disposed within the cavity. The portion of the wall of the housing structure can be electrically conductive.

The filter device of the present invention can further comprise a boss which is welded to the portion of the wall with the sensor being threaded into the boss. Alternatively, the sensor can be irremovably attached to the portion of the wall. In certain embodiments of the present invention, it can further comprise a thermally insulative region disposed between the external end of the sensor and the portion of the wall.

### BRIEF DESCRIPTION OF THE DRAWINGS

The present invention will be more fully and completely understood from a reading of the description of the preferred embodiment in conjunction with the drawings, in which:

FIG. 1 is a sectioned isometric view of one embodiment of the present invention;

FIG. 2 is a sectioned isometric view of an alternative embodiment of the present invention;

FIG. 3 is a third embodiment of the present invention;

FIG. 4 is a fourth embodiment of the present invention; and

FIG. 5 is an enlarged view of a portion of FIG. 4.

### DESCRIPTION OF THE PREFERRED EMBODIMENT

Throughout the description of the preferred embodiment of the present invention, like components will be identified by like reference numerals.

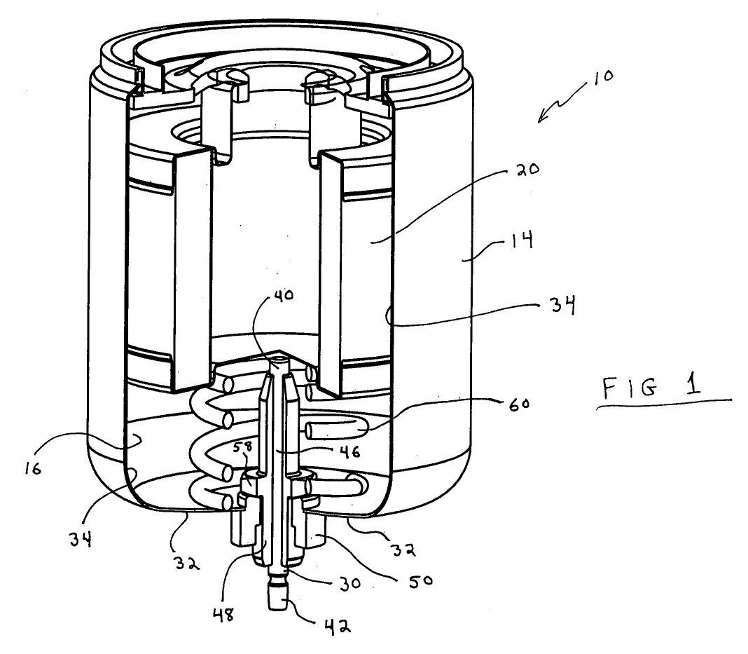

FIG. 1 is an isometric section view of a water separating fuel filter 10 made in accordance with a preferred embodiment of the present invention. It comprises a housing structure 14 which defines a cavity 16 therein. A filter medium 20 is disposed within the cavity 16 of the housing structure 14. When the water separating fuel filter 10 is attached to a fuel system of an internal combustion engine, fuel is caused to flow into the housing structure 14 in the region of the cavity 16 surrounding the outer circumferential surface of the filter medium 20. The fuel then flows radially inwardly through the filter medium material and is conducted to the cylinders of the engine. The filter medium 20 is particularly configured to be impermeable to water that may be entrained within the fuel. This water remains in the portion of the cavity 16 surrounding the filter medium 20 and, because the water is denser than the fuel, it collects in the bottom region of the housing structure 14. A sensor 30 extends through a portion 32 of a wall 34 of the housing structure 14. The sensor 30 has an internal end 40 disposed within the cavity 16 and an external end 42 which extends away from the housing structure 14. The sensor 30 is configured to prevent the sensor from being removed from the housing structure 14 in a direction which causes the internal end 40 to pass through the portion 32 of the wall 34 in a direction away from the cavity 16. In other words, the sensor 30 shown in FIG. 1 is prevented from being removed from the housing structure 14 in a downward direction in the illustration. This removal in a downward direction in FIG. 1 would cause the internal end 40 to pass through the portion 32 of the wall 34 through which the sensor 30 extends.

In the embodiment of the present invention shown in FIG. 1, the sensor 30 is a water detecting sensor that comprises an electrically conductive core 46. In a particularly preferred embodiment of the present invention, this electrically conductive core 46 is made of stainless steel. The sensor 30 further comprises an electrically insulative member 48, in a preferred embodiment of the present invention, which is disposed between the electrically conductive core 46 and the portion 32 of the wall 34. This electrically insulative member 48 can be made of plastic, an elastomeric material, or a ceramic material in a particularly preferred embodiment of the present invention.

The embodiment of the present invention shown in FIG. 1 also comprises a boss 50 which can be welded to the portion 32 of the wall 34. This boss 50 can also be threaded to receive threads formed on an outer surface of the electrically insulative member 48.

With continued reference to FIG. 1, a flange element extends outwardly from the electrically insulative member 48. This flange element 58 is provided with six flat sides which facilitate the tightening of the sensor 30 to the boss 50. It can also be seen that the flange element 58 prevents the downward movement of the insulative member 48 through the opening described by the boss 50. As a result, since the electrically conductive core 46 is attached to the electrically insulative member 48, the flange element 58 prevents the downward movement of the sensor 30 through the opening formed in the boss 50. The only way that the sensor 30 can be removed from the housing structure 14 is in an upward direction through the cavity 16. With the filter medium 20 removed from the housing structure 14, the sensor 30 can be loosened from its threaded attachment to the boss 50 and moved in an upward direction in FIG. 1 through the cavity 16 when the sensor 30 must be replaced. Otherwise, the sensor 30 is configured to prevent its removal in the opposite direction downwardly through the portion 32 of the wall 34.

With continued reference to FIG. 1, it can also be seen that a spring 60 is provided to exert an upward force on the filter medium 20. In its most basic form, the sensor 30 operates by detecting an electric current conducted by water. This current between the internal end 40 and the housing structure 14 indicates that water is present in the region of the internal end 40. This represents the presence of sufficient water within the cavity 16 to require replacement of the water separating fuel filter or, at a minimum, the removal of the water contained within the cavity 16.

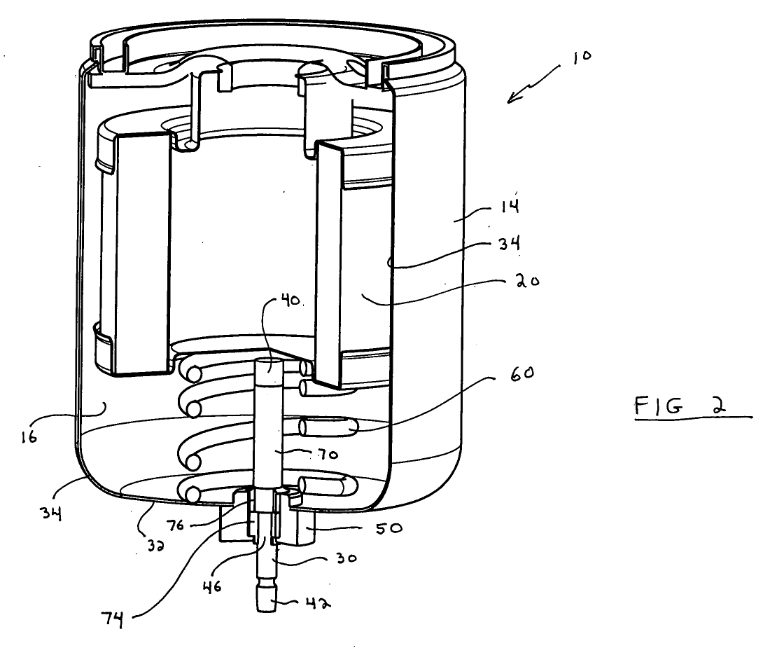

FIG. 2 shows an alternative embodiment of the present invention. The core 46 is coated with a dielectric coating such as an epoxy 70. The internal end 40 remains uncoated. Similarly, the external end 42 is uncoated. A high temperature, fuel resistant elastomeric material 74, such as fluoroelastomer (FKM) or perfluoroelastomer (FFKM) is provided as an electrically insulative structure and also a seal between the core 46 and the boss 50. In addition, an adhesive 76 is provided to bond the core 46 to the boss 50 and to also provide a redundant seal around the sensor 30. The shape of the core 46 and its coating 70 is configured to prevent the removal of the core 46 in a downward direction through the boss. In fact, the use of the adhesive 76 is intended to prevent the removal of the sensor 30 from the housing structure 14 without the destruction of the water separating fuel filter 10.

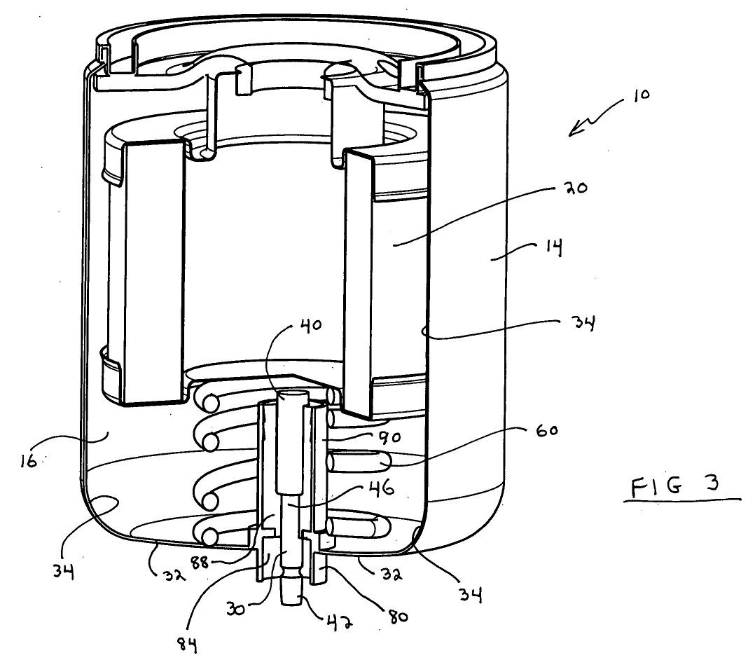

Regulations relating to inboard marine engines require that the engines must sustain a 2.5 minute fire test. The various high temperature insulator concepts associated with the present invention help to assure that the structure will pass the fire test requirement. FIG. 3 shows an alternative embodiment of the present invention. A welded insert 80 provides a heat isolation air cavity 84 surrounding a lower portion of the core 46. Air, which is temporarily trapped within the air cavity 84 when the mating electrical connector is present, delays the effect of heat on the elastomeric material 88 which provides a seal between the liquid in the cavity 16 and the surrounding area outside of the housing structure 14 and below the portion 32 of the wall 34. This elastomeric material 88 also provides electrical insulation between the core 46 and the upper portion 90 of the welded insert 80. The diametric configuration of the core 46 is configured to prevent the removal of the sensor 30 from the housing structure 14 in a downward direction which would cause the internal end 40 to pass through the portion 32 of the wall 34 through which the sensor 30 extends. The embodiment shown in FIG. 3 is intended to prevent the sensor 30 from being removed from the housing structure 14 in any direction.

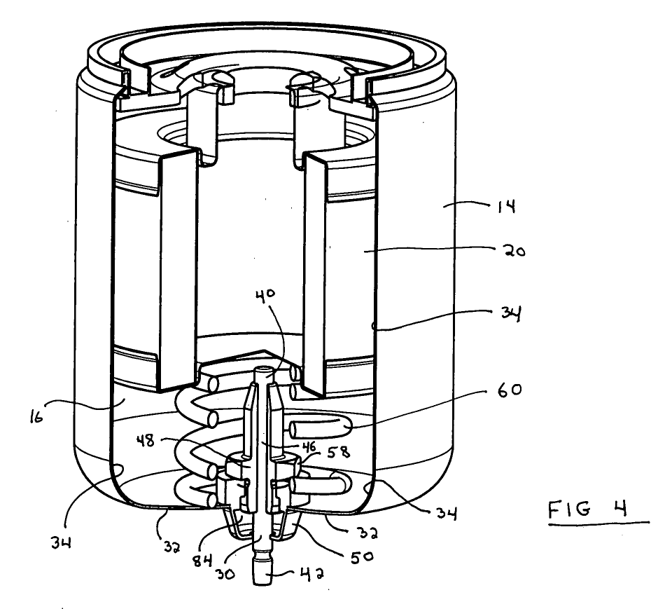

The embodiment of the present invention shown in FIG. 4 provides a welded boss 50 that more or less completely encloses the air cavity 84 when the mating electrical connector is present. The electrically insulative member 48 is provided with the flange 58, as described above in conjunction with FIG. 1, which assists in the assembly of the sensor 30 into the boss 50. In addition, the flange 58 prevents the downward movement of the sensor 30 through the portion 32 of the wall 34 through which the sensor 30 extends. The other components identified in FIG. 4 are generally similar to their counterparts which have been described above.

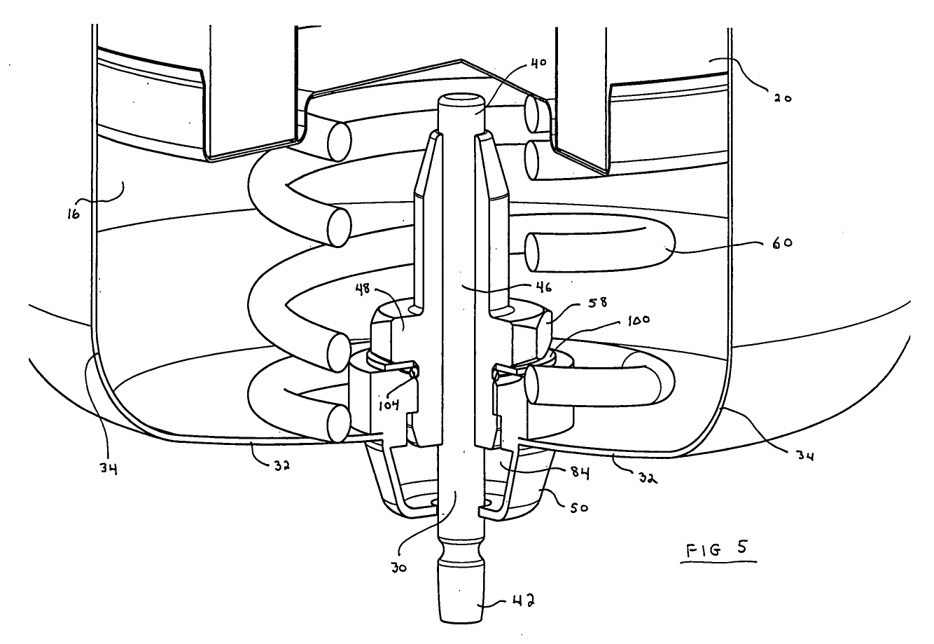

FIG. 5 is an enlarged view of the lower portion of FIG. 4. The heat isolation air cavity 84 is contained within the boss 50 which, in turn, is welded to the portion 32 of the wall 34 through which the sensor 30 extends. A sealing washer made of Teflon coated steel 100 is provided under the flange 58 and an FFK or FFKM elastomer o-ring 104 is disposed under the sealing washer 100 to provide additional sealing. The electrically insulative member 48 is made of a high temperature electrically insulative plastic that is molded over the core 46 prior to its insertion into the upper portion of the boss 50. This electrically insulative member 48 is provided with external threads that are received in threads formed in an internal opening of the boss structure. To further add to the redundant sealing, a sealing compound may be applied to the threads on the electrically insulative member 48 prior to installation into the boss 50.

With continued reference to FIG. 5, the heat isolation air cavity 84 is intended to slow the potentially destructive effect that a fire below the housing structure 14 can have on the non-metallic portions of the heat sensor 30. This air cavity 84 is not intended to prevent any such heat damage but, instead, is intended to delay the formation of a path through or around the sensor structure through which liquid fuel can flow from the cavity 16 to a region below the portion 32 of the wall 34 through which the sensor extends.

With reference to FIGS. 1-5, it can be seen that a filter device made in accordance with various preferred embodiment of the present invention comprises a housing structure 14 which defines a cavity 16 therein. A filter medium 20 is disposed within the housing structure 14. A sensor 30 extends through a portion 32 of a wall 34 of the housing structure 14. The sensor 30 has an internal end 40 disposed within the cavity 16 and an external end 42 which extends away from the housing structure 14. The sensor 30 is configured to prevent the sensor from being removed from the housing structure 14 in a direction which causes the internal end 40 to pass through the portion 32 of the wall 34 in a direction away from the cavity 16. In other words, in the embodiments shown in the figures, the sensor 30 is prevented from being removed in a downward direction which causes the internal end 40 to move out of the cavity 16 in a direction which causes it to pass through the portion 32 of the wall 34. In certain embodiments of the present invention, the sensor 30 can be removed in an upward direction into and through the cavity 16 which causes the external end 42 to move upwardly through the portion 32 of the wall 34 and into the cavity 16. The primary purpose of this configuration is to prevent the inadvertent removal of the sensor in a downward direction which would expose an opening through the portion 32 of the wall 34 through which liquid fuel can flow. In this way, the present invention prevents the removal of the sensor 30 from the housing structure 14 without the complete removal of the housing structure 14 from the fuel system of an internal combustion engine. As a result, inadvertent omission or removal of the sensor 30 will not cause a flow of liquid fuel into the bilge portion of a marine vessel.

The filter device can be a water separating fuel filter 20 and the sensor 30 can be removable from the portion 32 of the wall 34 in a direction into the cavity 16 defined by the housing structure 14. The portion 32 of the wall 34 can be proximate a bottom of the housing structure when the filter is operative and connected to a fuel system of an internal combustion engine. The sensor 30 can be a water detecting sensor and it can comprise an electrically conductive core 46 which can be made of stainless steel. The sensor 30 can also comprise an electrically insulative member 48 disposed between the electrically conductive core 46 and the portion 32 of the wall 34. The electrically insulative member 48 can be made of plastic, an elastomeric material, a ceramic material, or any other suitable electrically insulative material. In one embodiment of the present invention, the sensor 30 is prevented from being removed from the housing structure 14, in a direction which causes the internal end 40 to pass through the portion 32 of the wall 34 in a direction away from the cavity 16, by a flange element 58 which is attached to the sensor 30 and disposed within the cavity 16. The portion 32 of the wall 34 can be electrically conductive. A boss 50 can be welded to the portion 32 of the wall 34. The sensor 30 can be threaded into the boss 50.

In certain embodiments of the present invention, the sensor 30 is irremovably attached to the portion 32 of the wall 34. A thermally insulative region, or air cavity 84, can be disposed between the external end 42 of the sensor 30 and the portion 32 of the wall 34.

Although the present invention has been described with particular specificity and illustrated to show several preferred embodiments, it should be understood that alternative embodiments are also within its scope.

1. A filter device, comprising:
a housing structure which defines a cavity therein;
a filter medium disposed within said housing structure; and
a sensor extending through a portion of a wall of said housing structure, said sensor having an internal end disposed within said cavity and an external end which extends away from said housing structure, said sensor being configured to prevent said sensor from being removed from said housing structure in a direction which causes said internal end to pass through said portion of said wall in a direction away from said cavity,
wherein:
said sensor is prevented from being removed from said housing structure, in a direction which causes said internal end to pass through said portion of said wall in a direction away from said cavity, by a flange element attached to said sensor and disposed within said cavity and spaced from said portion of said wall.

2. The filter device of claim 1, wherein:
said filter device is a water separating fuel filter.

3. The filter device of claim 1, wherein:
said sensor is removable from said portion of said wall in a direction into said cavity.

4. The filter device of claim 1, wherein:
said portion of said wall is proximate a bottom of said housing structure when said filter is operative.

5. The filter device of claim 1, wherein:
said sensor is a water detecting sensor.

6. The filter device of claim 1, wherein:
said sensor comprises an electrically conductive core.

7. The filter device of claim 6, wherein:
said electrically conductive core is made of stainless steel.

8. The filter device of claim 6, wherein:
said sensor comprises an electrically insulative member disposed between said electrically conductive core and said portion of said wall.

9. The filter device of claim 8, wherein:
said electrically insulative member is made of plastic.

10-12. (canceled)

13. The filter device of claim 1, wherein:
said portion of said wall is electrically conductive.

14. The filter device of claim 1, further comprising:
a boss which is welded to said portion of said wall, said sensor being threaded into said boss.

15. (canceled)

16. The filter device of claim 1, further comprising:
a thermally insulative region disposed between said external end of said sensor and said portion of said wall.

17. A water separating fuel filter, comprising:
a housing structure which defines a cavity therein;
a filter medium disposed within said housing structure; and
a water sensor extending through a portion of a wall of said housing structure, said water sensor having an internal end disposed within said cavity and an external end which extends away from said housing structure, said water sensor being configured to prevent said water sensor from being removed from said housing structure in a direction which causes said internal end to pass through said portion of said wall in a direction away from said cavity,
wherein:
said water sensor is prevented from being removed from said housing structure, in an axially downward direction which causes said internal end to pass through said portion of said wall in a direction away from said cavity, by a flange element attached to said water sensor and disposed within said cavity and spaced axially above said portion of said wall.

18. The filter device of claim 17, wherein:
said water sensor is removable from said portion of said wall in a direction into said cavity.

19. The filter device of claim 17, wherein:
said portion of said wall is proximate a bottom of said housing structure when said filter is operative.

20. The filter device of claim 17, wherein:
said water sensor comprises an electrically conductive core.

21. The filter device of claim 20, wherein:
said electrically conductive core is made of stainless steel.

22. The filter device of claim 21, wherein:
said water sensor comprises an electrically insulative member disposed between said electrically conductive core and said portion of said wall.

23. (canceled)

24. The filter device of claim 17, further comprising:
a boss which is welded to said portion of said wall, said water sensor being threaded into said boss.

25. (canceled)

26. The filter device of claim 17, further comprising:
a thermally insulative region disposed between said external end of said water sensor and said portion of said wall.

27. A water separating fuel filter device, comprising:
a housing structure which defines a cavity therein;
a filter medium disposed within said housing structure; and
a water detecting sensor extending through a portion of a wall of said housing structure, said water detecting sensor having an internal end disposed within said cavity and an external end which extends away from said housing structure, said water detecting sensor being configured to prevent said water detecting sensor from being removed from said housing structure in a direction which causes said internal end to pass through said portion of said wall in a direction away from said cavity,
wherein:
said water detecting sensor is prevented from being removed from said housing structure, in an axially downward direction which causes said internal end to pass through said portion of said wall in a direction away from said cavity, by a flange element attached to said water detecting sensor and disposed within said cavity and spaced axially above said portion of said wall.

28. The water separating fuel filter device of claim 27, wherein:
said water detecting sensor is removable from said portion of said wall in a direction into said cavity.

29. The water separating fuel filter device of claim 27, wherein:
said water detecting sensor comprises an electrically conductive core.

30. The water separating fuel filter device of claim 29, wherein:
said water detecting sensor comprises an electrically insulative member disposed between said electrically conductive core and said portion of said wall.

31. (canceled)

32. The water separating fuel filter device of claim 27, further comprising:
a boss which is welded to said portion of said wall, said water detecting sensor being threaded into said boss.

33. (canceled)

34. The water separating fuel filter device of claim 27, further comprising:
a thermally insulative region disposed between said external end of said water detecting sensor and said portion of said wall.
